(19) United States
(12) Patent Application Publication
(10) Pub. No.: US 2020/0064778 A1
(43) Pub. Date: Feb. 27, 2020

(54) ACCESSORY SUITABLE FOR BEING MOUNTED ON DIFFERENT ATTACHMENT ELEMENTS

(71) Applicant: Marie-Amélie GUILLOT, (US)

(72) Inventors: Marie-Amélie GUILLOT, Paris (FR); Frédéric RICHARD, Concise (CH)

(21) Appl. No.: 16/489,065

(22) PCT Filed: Jan. 31, 2018
(86) PCT No.: PCT/FR2018/050222

§ 371 Date: Aug. 27, 2019

(30) Foreign Application Priority Data
Feb. 28, 2017 (FR) FR1751611

(51) Int. Cl. G04B 37/14

(52) U.S. Cl. CPC G04B 37/1486; G04B 37/1446; G04B 37/1413

(57) ABSTRACT

An accessory having a first face and a second face connected by a lateral face, the second face having a slot extending to the lateral face, forming on the lateral face a hole the shape defined by the transverse cross-section of the slot. The transverse cross-section has an open contour having a bottom and an opening connected by a first lateral side and a second lateral side, the first lateral side and the second lateral side each having a part approaching from the bottom towards the opening, towards the opposite lateral side. The dimension of the bottom of the contour are constant along a direction defined by a direction extending substantially perpendicular to the transverse cross-section and going from the hole towards an inner part of the accessory. The slot is intended to receive a fastener.

The invention relates to the field of watches or personal accessories that can be mounted on different fasteners, and more specifically to the use of a watch case that can be mounted as a wristwatch, pocket watch, table clock, pendant or other.

Watches generally comprise one or more fasteners, making it possible to limit the risk of losing the watch when being worn on one's person, or to have the watch in a position allowing easy reading of the time displayed thereby. The fasters are, for example, a wristband for attaching the watch around the wrist, a chain for attaching the watch to a buttonhole, a lanyard or another support for placing the watch on a substantially horizontal plane, at a desired angle.

Enabling a pocket watch to be worn as a wristwatch is a known problem.

Indeed, there are wristbands comprising a housing in which a pocket watch can be placed, the housing securing the pocket watch to the wristband. There are also wristbands comprising arms in the form of clips, to which the pocket watch can be attached.

Document GB 191505485 describes a watch case comprising two opposite loops. A chain is capable of being attached to one of the two loops to form a pocket watch, or to both loops to form a wristwatch.

Document U.S. Pat. No. 4,976,548 discloses an example of watch, the watch case whereof comprises loops at the periphery thereof. A chain is capable of being attached in different ways to the loops, so as to produce either a wristband or a pendant.

All these examples show that the person skilled in the art has long sought to adapt a pocket watch as a wristwatch.

However, such devices only attempt to adapt pocket watches, and not to devise a watch capable of being worn both as a wristwatch or pocket watch, without the watch appearing to have been adapted in either one of those configurations. Moreover, such devices are uncomfortable to wear and/or considerably increase the size of the watch, increasing thereby its bulk and weight.

A first objective is to propose a personal accessory, for a watch for example, capable of being mounted either on a wristband or on a fastener.

Another objective is to propose a fastener for such an accessory on a wristband, a loop or a support.

Another objective is to propose a device comprising such an accessory and such a fastener.

Another objective is to propose such a device, for which the accessory and fastener are capable of being assembled without a tool.

Another objective is to propose such a device that does not negatively affect the aesthetics, weight, bulk or the comfort of wearing it, irrespective of the type of mounting chosen.

To that end, proposed first is a personal accessory for a watch, for example, comprising:
a first face,
a second face,
a lateral face connecting the first face and the second face,
   the second face comprising a slot extending to the lateral face, so as to form, on said lateral face, a hole the shape whereof is defined by a transverse cross-section of the slot, the slot having, in transverse cross-section, an open contour, the contour comprising:
a bottom,
a first lateral side,
a second lateral side,
an opening,
   the first lateral side and the second lateral side connecting the bottom and the opening, the first lateral side comprising a first part approaching, from the bottom towards the opening, towards the second lateral side, the second lateral side comprising a second part approaching, from the bottom towards the opening, towards the first lateral side, the dimension of the bottom of the contour being constant or decreasing along a direction defined by a direction extending substantially perpendicular to the transverse cross-section of the slot and going from the hole of the lateral face towards an internal part of the accessory, said slot being intended to receive a fastener.

Various additional characteristics can be foreseen, alone or in combination:
the bottom and the opening of the contour of the transverse cross-section of the slot each forms a straight segment, which segments are substantially parallel to each other, the first lateral side and the second lateral side of the contour each comprises a first retaining segment substantially perpendicular to the bottom and to the opening, an intermediate retaining segment substantially parallel to the bottom and to the opening and a second retaining segment substantially perpendicular to the bottom and to the opening, such that the transverse cross-section of the slot is generally T-shaped;
the slot crosses the accessory, forming two holes on the lateral face;
the accessory comprises a magnet, the magnet being intended to hold a relative position between the accessory and the fastener.

Secondly, proposed is a fastener having in transverse cross-section a closed perimeter comprising:
a first facet,
a second facet,
a first lateral edge,
a second lateral edge,
   the first lateral edge and the second lateral edge connecting the first facet and the second facet to each other, the first lateral edge comprising a first portion approaching, from the first facet towards the second facet, towards the second lateral edge, the second lateral edge comprises a second portion approaching, from the first facet towards the second facet, towards the first lateral edge, the dimension of the first facet of the perimeter being constant or decreasing along a direction extending substantially perpendicular to the transverse cross-section of the fastener, said fastener being intended to be inserted into a slot of an accessory.

Various additional characteristics can be foreseen, alone or in combination:
the first facet and the second facet of the perimeter of the transverse cross-section of the fastener each forms a straight segment, which segments are substantially parallel to each other, the first lateral edge and the second lateral edge of the perimeter each comprises a first locking segment substantially perpendicular to the first facet and to the second facet, an intermediate locking segment substantially parallel to the first facet and to the second facet and a second locking segment substantially perpendicular to the first facet and to the second facet, such that the transverse cross-section of the fastener is generally T-shaped;
the member comprises two lugs or a loop projecting from the body of the fastener, the lugs being disposed substantially parallel to each other, the loop being generally ring-shaped, the lugs, respectively the loop, being intended to secure a wristband, respectively a chain, to the fastener;
the fastener comprises a second magnet, the second magnet being intended to hold a relative position between the fastener and the accessory.

Thirdly, proposed is a device comprising an accessory and a fastener as presented above, the fastener having a shape complementary to the slot of the accessory, the fastener being inserted into the slot of the accessory.

Fourthly, proposed is a watch comprising an accessory and a fastener as presented above, the accessory comprising a cavity into which a watch movement is inserted, the accessory thus defining a watch case, the fastener having a shape complementary to the slot of the watch case, the fastener being capable of being inserted into the slot of the watch case.

Such a device thus makes it possible to mount the accessory on a wristband, a loop or a support by means of the fastener.

The accessory and the fastener are capable of being assembled quickly and without a tool.

The device does not negatively affect the aesthetic, weight, bulk or comfort of the wearing thereof, irrespective of the type of mounting chosen.

Other characteristics and advantages of the invention will be seen more clearly and specifically from the following description of embodiments, which is provided with reference to the appended drawings in which:

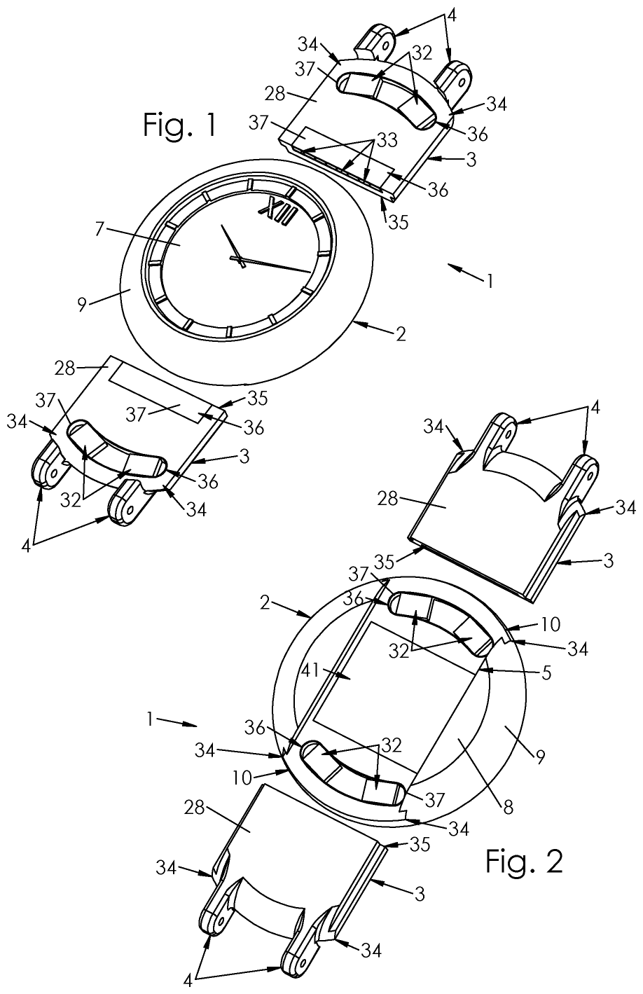

FIG. 1 is an exploded schematic top view in perspective of a watch case, mounted as a wristwatch;

FIG. 2 is an exploded schematic top view in perspective of a watch case, mounted as a wristwatch, as shown in FIG. 1;

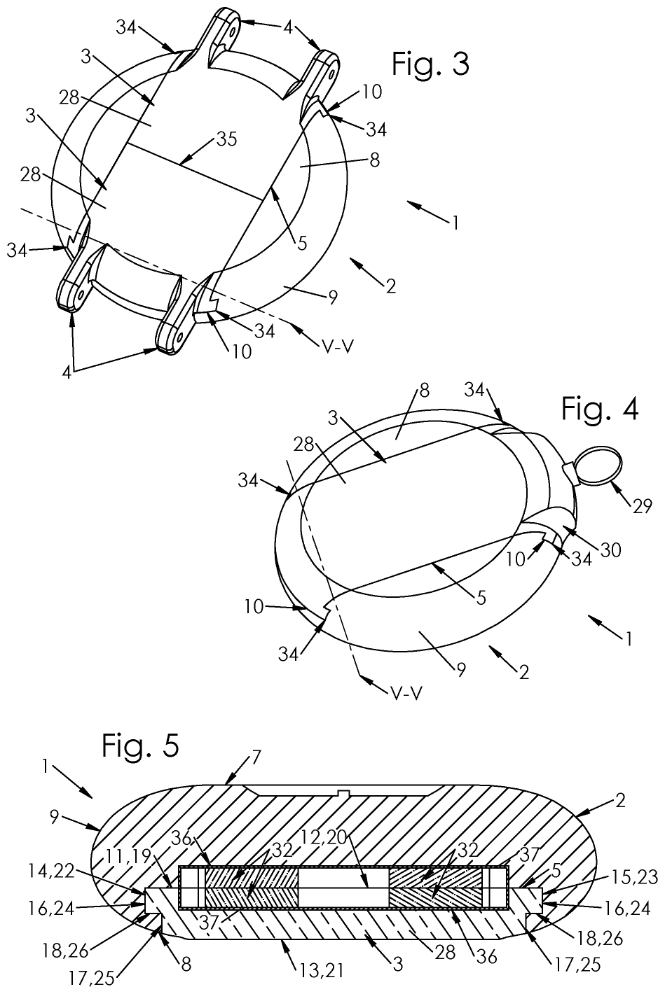

FIG. 3 is a schematic bottom view in perspective of the watch case, mounted as a wristwatch, as shown in FIGS. 1 and 2;

FIG. 4 is a schematic bottom view in perspective of a watch case shown in FIGS. 1 to 3, mounted as a pocket watch;

FIG. 5 is a cross-sectional schematic view of the watch case, which can be mounted both as a wristwatch or a pocket watch, along line V-V, as shown in FIGS. 3 and 4;

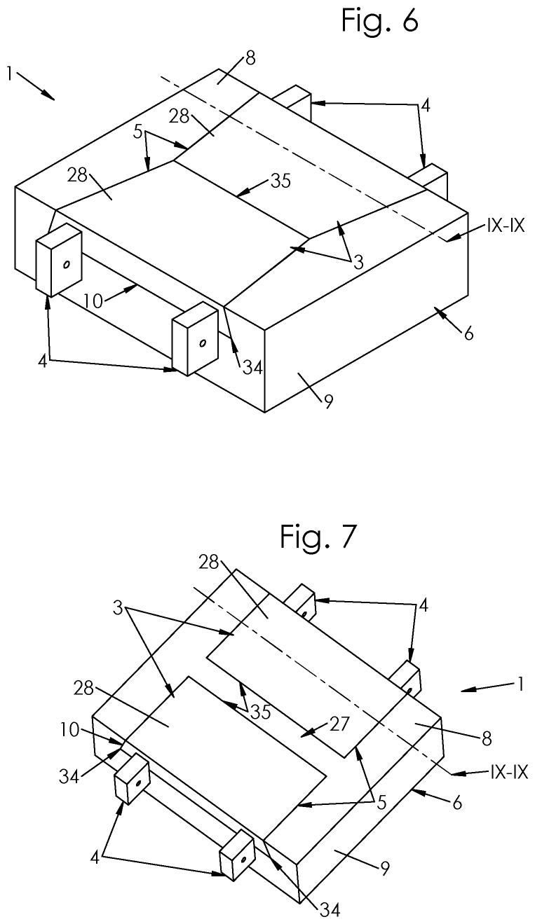

FIG. 6 is a schematic bottom view in perspective of one embodiment of an accessory, mounted on a wristband;

FIG. 7 is a schematic bottom view in perspective of another embodiment of an accessory, mounted on a wristband;

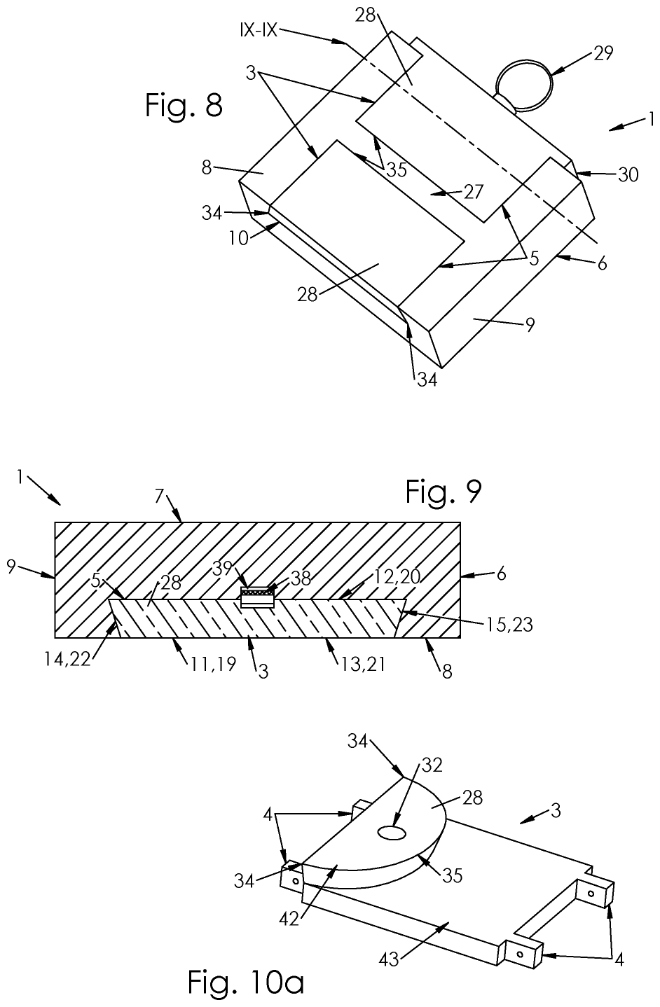

FIG. 8 is a schematic bottom view in perspective of the embodiment of the accessory, shown in FIG. 7, mounted on a loop;

FIG. 9 is a cross-sectional schematic view of embodiments of the accessory, which can be mounted both on a wristband or on a loop, along line IX-IX shown in FIGS. 6 to 8;

FIG. 10a is a schematic top view in perspective of another embodiment of a fastener of an accessory;

FIG. 10b is a schematic bottom view in perspective of an accessory compatible with the fastener, according to the embodiment shown in FIG. 10a;

FIG. 10c is a schematic bottom view in perspective of the accessory mounted on the fastener, according to the embodiment shown in FIGS. 10a and 10b;

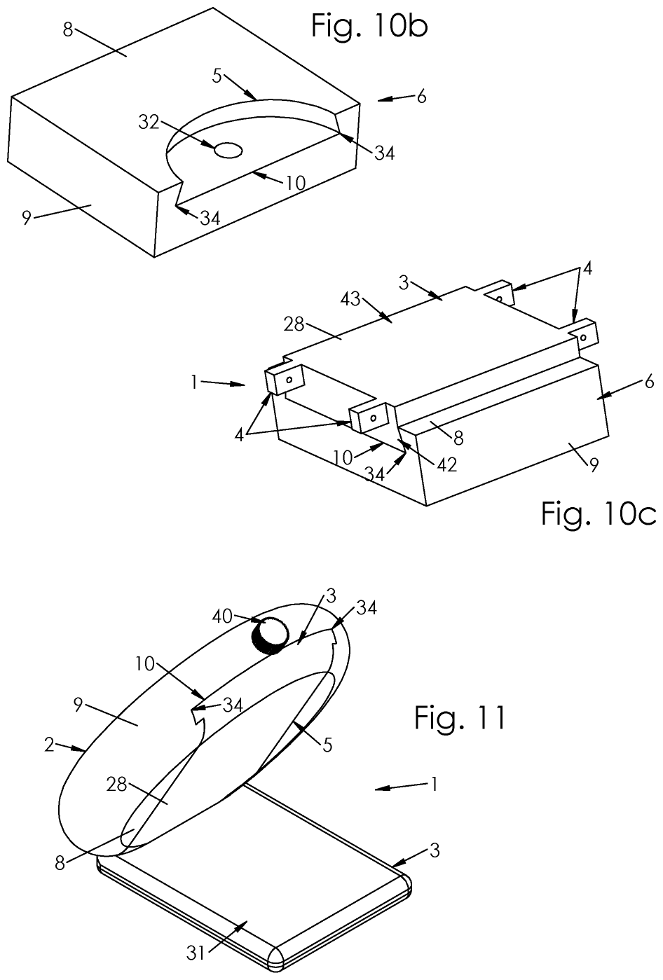

FIG. 11 is a schematic view in perspective of a watch case, shown in FIGS. 1 to 5, mounted as a table clock;

Illustrated in FIGS. 1 and 2 is a first embodiment of a device 1 comprising a watch case 2, and two fasteners 3, each fitted with a pair of lugs 4. Each pair of lugs 4 is intended to secure one part of a wristband (not shown) to the fastener 3, so as to form a wristwatch.

The watch case 2 comprises a slot 5 into which the fastener 3 is able to slide. The fastener 3 has a shape complementary to the slot 5.

The watch case 2 is only a first embodiment, shown in FIGS. 1 to 5 and 11, and does not limit the invention to the design of a watch. Indeed, according to other embodiments, shown in FIGS. 6 to 10c, the device 1 comprises a portable accessory 6 (jewelry, pendant, key ring, small electronic appliance, etc.), intended to be attached to different fasteners 3 (wristband, brooch, necklace, long necklace, ring, earring, belt buckle, pin, etc.).

The watch case 2 and respectively the accessory 6, comprise a first face 7, a second face 8 and a lateral face 9 connecting the first face 7 and the second face 8.

According to represented embodiments, the first face 7 corresponds to the face of the watch case 2 and of the accessory 6 comprising information (time, jewel, connected information, etc.) intended to be viewed. According to other embodiments, said information is shown on the second face 8 or on the first face 7 and the second face 8 of the watch case, and respectively of the accessory 6.

As shown in FIGS. 1 to 4 and 11, the watch case 2 is generally substantially cylindrical in shape, with circular cross-section. The height of the lateral face 9 is far smaller than the dimension of the first face 7 and of the second face 8. The first face 7 and the second face 8 are substantially identical in shape.

As illustrated in FIGS. 6 to 8 and 10a to 10c, the accessory 6 is generally parallelepiped in shape. The height of the lateral face 9 is far smaller than the dimension of the first face 7 and of the second face 8. The first face 7 and the second face 8 are substantially identical in shape.

According to different embodiments, the watch case 2 and the accessory 6 have any shape whatsoever.

The fastener 3, preferably has a general shape complementary to the slot 5 in which the fastener 3 is intended to be inserted, so as to complete the form of the watch case 2 or the accessory 6.

The slot 5 forms, in the lateral face 9, a hole 10 intended to allow the entry of the fastener 3 into the slot 5.

In the embodiments represented in FIGS. 7 and 8, the slot 5 is generally rectangular in shape.

According to different embodiments, the slot 5 is generally triangular or elliptical in shape, as represented respectively in FIGS. 6 and 10a to 10c.

According to embodiments not shown, the slot generally has any shape whatsoever, except for the particularity that the slot 5 flares towards the hole 10 formed in the lateral face 9. In other words, a transverse cross-section of the slot 5 has a decreasing dimension from the hole 10 towards one end of the slot 5 opposite the hole 10.

As shown in FIGS. 5 and 9, the slot 5 of the watch case 2, respectively of the accessory 6, has an open contour 11 in transverse cross-section. The contour 11 comprises a bottom 12, an opening 13, a first lateral side 14 and a second lateral side 15. The first lateral side 14 and the second lateral side 15 connect the bottom 12 and the opening 13.

According to the first embodiment, illustrated in FIG. 5, the bottom 12 and the opening 13 each defines a straight segment. The bottom 12 and the opening 13 are substantially parallel to each other. The first lateral side 14 and the second lateral side 15 each comprises a first retaining segment 16, connected to the bottom 12, a second retaining segment 17, connected to the opening 13 and an intermediate retaining segment 18, connecting the first retaining segment 16 and the retaining segment 17.

The first retaining segment 16 of the first lateral side 14 and the first retaining segment 16 of the second lateral side 15 are substantially perpendicular to the bottom 12. The second retaining segment 17 of the first lateral side 14 and the second retaining segment 17 of the second lateral side 15 are substantially perpendicular to the opening 13. The intermediate retaining segment 18 of the first lateral side 14 and the intermediate retaining segment 18 of the second lateral side 15 are, respectively, substantially perpendicular to the first retaining segments 16 and to the second retaining segments 17. Thus, the slot 5 defines a T-shape in transverse cross-section.

According to other embodiments illustrated in FIG. 9, the bottom 12 and the opening 13 each define a straight segment. The bottom 12 and the opening 13 are substantially parallel to each other. The first lateral side 14 and the second lateral side 15 each define a straight segment approaching each other from the bottom 12 towards the opening 13. Thus, in transverse cross-section the slot 5 defines a substantially trapezoidal shape.

According to a different embodiment, in transverse cross-section the slot 5 has a shape of any kind, except that the first lateral side 14 and the second lateral side 15 respectively comprise a first part and a second part extending, from the bottom 12 towards the opening 13, towards the opposite lateral side 14, 15.

The first lateral side 14 and the second lateral side 15, in the entirety thereof or at least the first part and the second part thereof, thus make it possible to prevent the release of the fastener 3 from the slot 5 along a direction substantially perpendicular to the opening 13.

As shown in FIGS. 5 and 9, in transverse cross-section the fastener 3 has a closed perimeter 19. The perimeter 19 comprises a first facet 20, a second facet 21, a first lateral edge 22 and a second lateral edge 23. The first lateral edge 22 and the second lateral edge 23 connect the first facet 20 and the second facet 21 to each other.

According to the first embodiment, illustrated in FIG. 5, the first facet 20 and the second facet 21 each defines a straight segment. The first facet 20 and the second facet 21 are substantially parallel to each other. The first lateral edge 22 and the second lateral edge 23 each comprises a first locking segment 24 connected to the first facet 20, a second locking segment 25 connected to the second facet 21, and an intermediate locking segment 26 connecting the first locking segment 24 and the second locking segment 25.

The first locking segment 24 of the first lateral edge 22 and the first locking segment 24 of the second lateral edge 23 are substantially perpendicular to the first facet 20. The second locking segment 25 of the first lateral edge 22 and the second locking segment 25 of the second lateral edge 23 are substantially perpendicular to the second facet 21. The intermediate locking segment 26 of the first lateral edge 22 and the intermediate locking segment 26 of the second lateral edge 23 are, respectively, substantially perpendicular to the first locking segments 24 and to the second locking segments 25. Thus, in transverse cross-section the fastener 3 defines a T-shape.

According to other embodiments illustrated in FIG. 9, the first facet 20 and the second facet 21 each defines a straight segment. The first facet 20 and the second facet 21 are substantially parallel to each other. The first lateral edge 22 and the second lateral edge 23 each defines a straight segment approaching each other from the first facet 20 towards the second facet 21. Thus, in transverse cross-section the fastener 3 defines a substantially trapezoidal shape.

According to a different embodiment, in transverse cross-section the fastener 3 has a shape of any kind, except that the first lateral edge 22 and the second lateral edge 23 respectively comprise a first portion and a second portion extending, from the first facet 20 towards the second facet 21, towards the opposite lateral edge 22, 23.

The first lateral edge 22 and the second lateral edge 23, in the entirety thereof or at least the first part and the second part thereof, thus make it possible to prevent the release of the fastener 3 from the slot 5 along a direction substantially perpendicular to the opening 13 of the slot 5.

According to the first embodiment represented in FIGS. 1 to 5 and 11 and a second embodiment illustrated in FIG. 6, the slot 5 of the watch case 2, and in respect of the accessory 6, crosses the watch case 2, in respect of the accessory 6, creating an elongated hole through the lateral face 9, the elongated hole extending from one end to the other of the watch case 2, in respect of the accessory 6. The slot 5 forms, in the lateral face 9, two holes 10. The holes 10 are preferably aligned along an axis substantially perpendicular to the transverse cross-section of the slot 5, as shown in FIGS. 2 to 4 and 6. The holes 10 are generally substantially identical in shape.

According to a third embodiment, the accessory 6 comprises two slots 5, as shown in FIGS. 7 and 8. The slots 5 are separated by a partition 27. Each slot 5 forms, in the lateral face 9, the hole 10. The slots 5 are preferably aligned along an axis substantially perpendicular to the transverse cross-section of the slot 5. The holes 10 are generally substantially identical in shape.

According to different embodiments, the watch case 2 comprises two slots 5. The watch case 2, and respectively the accessory 6, comprise a single non-through slot 5.

The fastener 3 of the device 1 is chosen based on the slot 5 of the watch case 2 or the accessory 6, according to one of the embodiments described below.

As illustrated in FIGS. 1 to 3 and 6 to 8, the device 1 comprises two fasteners 3. The fasteners 3 each comprises a body 28, preferably having a general shape that is substantially identical.

According to one embodiment shown in FIGS. 1 to 3, 6 and 7, each fastener 3 comprises a pair of lugs 4. Each lug 4 preferably protrudes from the body 28 so as to abut onto the watch case 2, or respectively the accessory 6, defining an end-of-travel of the fastener 3 when it is inserted into the slot 5.

According to one embodiment shown in FIG. 8, one of the two fasteners 3 comprises a loop 29. The loop 29 is intended to attach a chain, lanyard or any object (not shown) to the fastener 3, facilitating the handling, holding and/or securing of the device 1. The fastener 3 also preferably comprises an abutment 30 projecting from the body 28 of the fastener 3 abutting onto the watch case 2, or respectively the accessory 6, so as to define an end-of-travel of the fastener 3 when it is inserted into the slot 5.

The second of the two fasteners 3 preferably comprises only the body 28 complementing the slot 5.

As illustrated in FIGS. 4 and 10a to 11, the device 1 comprises a single fastener 3. The body 28 of the fastener 3 has a shape substantially identical to the shape of the slot 5 so as to complement the shape of the watch case 2, or respectively the accessory 6, into which the fastener 3 is inserted.

According to one embodiment illustrated in FIG. 4, the fastener 3 comprises the loop 29 intended to attach a chain, lanyard or any object (not shown) to the fastener 3, facilitating the handling, holding and/or securing of the device 1. The fastener 3 also preferably comprises the abutment 30 projecting from the body 28 of the fastener 3 so as to abut onto the watch case 2, or respectively the accessory 6, in order to define an end-of-travel of the fastener 3 when it is inserted into the slot 5.

According to one embodiment shown in FIG. 11, the fastener 3 comprises a support 31. The support 31 can be oriented relative to the body 28 of the fastener 3, allowing the device 1 to be positioned on a substantially horizontal plane at a desired angle. As a variant, the support 31 comprises a means of attachment to a non-horizontal object. The means of attachment is, for example, a magnet or an adhesive strip.

According to a fourth embodiment represented in FIGS. 10a to 10c, a fastener 3 comprises, preferably symmetrically, two pairs of lugs 4 integral with the body 28 of the fastener 3. The body 28 of the fastener 3 comprises a first part 42, capable of being inserted into a non-through slot 5 of the watch case 2, or respectively the accessory 6. The body 28 also comprises a second part 43, with which the lugs 4 are integral, extending from one end to the other of the watch case 2, or respectively the accessory 6. The second part forms an extra thickness, relative to the second face 8, when the fastener 3 is inserted into the slot 5.

The watch case 2, respectively the accessory 6, and/or the fastener 3 preferably comprise one or more coupling means. The coupling means are capable of securing the watch case 2, respectively the accessory 6, and the fastener 3 when the latter is inserted into the slot 5.

The coupling means are preferably magnets 32, 33 as illustrated in FIGS. 1, 2, 5, 10a and 10b, for example magnets of the rare earth type, particularly neodymium iron boron.

The watch case 2, respectively the accessory 6, and/or the fastener 3 thus preferably comprise one or more magnets 32,33.

According to the first embodiment shown in FIGS. 1 to 4, the watch case 2 and the fasteners 3 each comprise two end magnets 32. The end magnets 32 are positioned substantially at outer angles 34 of the slot 5 and respectively of the body 28 of the fasteners 3. The end magnets 32 are substantially parallelepiped in shape.

According to the first embodiment, the fasteners 3 also each comprise a plurality of central magnets 33. The central magnets 33 are positioned at an inner boundary 35 of the body 28 of the fasteners 3. The inner boundary 35 is opposite to the outer angles 34. The central magnets 33 are preferably positioned so that the pole of two consecutive central magnets 33 are not identical. The central magnets 33 are substantially parallelepiped in shape.

According to different embodiments, the magnets 32, 33 have any shape whatsoever.

According to different embodiments, the fasteners 3 comprise only the end magnets 32.

Advantageously, the end magnets 32 of the fasteners 3 are positioned substantially facing end magnets 32 of the watch case 2 when the fastener 3 is inserted into the slot 5 of the watch case 2.

According to the first embodiment shown in FIGS. 1 to 4, the central magnets 33 of each fastener 3 inserted into the slot 5 are positioned in such a way that two central magnets 33, pertaining respectively to one of the two fasteners 3 and positioned to face each other, are mutually attracting.

According to one embodiment, the partition 27 comprises central magnets 33.

The watch case 2 preferably comprises enclosures 36 into which the magnets 32, 33 are inserted. The enclosures 36 comprise walls 37 capable of blocking the electromagnetic waves, emitted by the magnet [sic: magnets] 32, 33 positioned therein, in every direction except for a predefined direction.

The enclosures 36 thus make it possible to insulate the magnets 32, 33 so as not to disturb the operation of the watch case 2 or an element exterior to the device 1 while ensuring the securing of the fastener 3 and of the watch case 2.

In a variant, the enclosures 36 are positioned in proximity to the magnets 32, 33, blocking the propagation of the electromagnetic waves emitted by the magnets 32, 33 along a single direction or along a plurality of predefined directions.

According to the second embodiment, shown in FIGS. 6 to 9, the fastener 3 comprises a flexible part 38, such as a spring or a curved blade, having a shape complementary to a recess 39 of the accessory 6. The flexible part 38 and the recess 39 are positioned substantially at the center of the body 28 of the fastener 3 and, respectively, the accessory 6.

In a variant, the coupling means are, for example, protrusions capable of forcibly penetrating into recesses, adhesive strips, or a general dimension of the fastener 3 substantially greater than the dimension of the slot 5 in such a way that the fastener 3 is forcibly inserted into the slot 5.

The coupling means described above are combinable, and can be dimensioned in such a way as to maintain the fastener 3 in place in the slot 5.

According to a different embodiment, the coupling means define the end-of-travel of the fastener 3 in the slot 5. Means can replace the projection of the lugs 4 on the lateral face 9 or the abutment 30.

The watch case 2 can either display the time analogically or digitally, from an automatic or battery-operated mechanism, or an electronic system.

According to the embodiment shown in FIG. 11, the watch case 2 comprises buttons (not shown) and in particular, a stem 40.

According to one embodiment, the stem 40 is positioned substantially on a bisector of the angle formed by the hands when they show 3 o'clock or 12:15. In this configuration, the stem 40 is positioned between the standard arrangement for a wristwatch (on a line that coincides with the hands when they indicate 3:15) and the standard arrangement for a pocket watch or a table clock (on a line that coincides with the hands when they indicate 12 o'clock).

According to different embodiments, the stem 40 is positioned on the line that coincides with the hands when they show 3:15 or on the line that coincides with the hands when they indicate 12 o'clock, as shown in FIG. 11.

As a variant, the stem 40 is movable between the last two positions described by a stem 40 support system on shafts provided for such purpose. The stem 40 can also be retractable, so as to merge into the lateral face 9 of the watch case 2, or be positioned invisibly such as in the slot 5.

Advantageously, the watch case 2 comprises, on the second face 8, a cavity into which a watch movement is inserted. The cavity preferably comprises walls 37 capable of blocking the electromagnetic waves emitted by the magnets 32, 33 in order to insulate said magnets so as not to disturb the operation of the movement.

The watch case 2 comprises a plate 41 closing the cavity and aligned with the second face 8. The plate 41 is transparent, for example, leaving the inside of the movement visible.

The plate 41 is preferably capable of blocking the electromagnetic waves emitted by the magnet [sic: magnets] 32, 33.

Such a device 1 thus makes it possible to mount the watch case 2, or respectively the accessory 6, on a wristband, a loop 29 or a support 31 by means of the fastener 3.

The watch case 2, or respectively the accessory 6, and the fastener 3 are capable of being assembled quickly and without a tool.

The device 1 does not negatively affect the aesthetic, weight, bulk or comfort of the wearing thereof, irrespective of the type of mounting chosen.

The device 1 as described makes it possible, for example, to assemble a watch in different types of watches such as a wristwatch, a pocket watch or a table clock, but also on other supports such as a pendant or a brooch.

Such a watch thus enables a simple and quick customization by changing the wristband or the way of wearing it, while ensuring a fastening strength between the watch case 2 and the fastener 3, the dimensions whereof can be determined easily, avoiding the separation thereof by their own weight or by being pulled off.

Because the magnets 32, 33 do not lose their magnetism spontaneously, they offer great longevity to the attachment between the watch case 2 and the fastener 3 of the watch

1. Personal accessory comprising:
a first face,
a second face,
a lateral face connecting the first face and the second face, the accessory being characterized in that the second face comprises a slot extending to the lateral face, so as to form, on said lateral face, a hole the shape whereof is defined by a transverse cross-section of the slot, the slot having, in transverse cross-section, an open contour, the contour comprising:
a bottom,
a first lateral side,
a second lateral side
an opening,
the first lateral side and the second lateral side connecting the bottom and the opening, the first lateral side comprising a first part approaching, from the bottom towards the opening, towards the second lateral side, the second lateral side comprising a second part approaching, from the bottom towards the opening, towards the first lateral side, the dimension of the bottom of the contour being constant or decreasing along a direction defined by a direction extending substantially perpendicular to the transverse cross-section of the slot and going from the hole of the lateral face towards an inner part of the accessory, said slot being intended to receive a fastener, the accessory comprising a magnet, the magnet being intended to maintain a relative position between the accessory and the fastener.

2. The personal accessory according to claim 1, characterized in that the bottom and the opening of the contour of the transverse cross-section of the slot each forms a straight segment substantially parallel to each other, the first lateral side and the second lateral side of the contour each comprises a first retaining segment substantially perpendicular to the bottom and to the opening, an intermediate retaining segment substantially parallel to the bottom and to the opening and a second retaining segment substantially perpendicular to the bottom and to the opening in such a way that the transverse cross-section of the slot is generally T-shaped.

3. The personal accessory according to claim 1, characterized in that the slot crosses the accessory forming, on the lateral face two holes.

4. A fastener having, in transverse cross section, a closed perimeter comprising:
a first facet,
a second facet,
a first lateral edge,
a second lateral edge,
the first lateral edge and the second lateral edge connecting the first facet and the second facet to each other, the fastener being characterized in that the first lateral edge comprises a first portion approaching, from the first facet towards the second facet, towards the second lateral edge, the second lateral edge comprises a second portion approaching, from the first facet towards the second facet, towards the first lateral edge, the dimension of the first facet of the perimeter being constant or decreasing along a direction extending substantially perpendicular to the transverse cross-section of the fastener said fastener being intended to be inserted into a slot of an accessory, the fastener comprising a second magnet, the second magnet being intended to maintain a relative position between the fastener and the accessory.

5. The fastener according to claim 4, characterized in that the first facet and the second facet of the perimeter of the transverse cross-section of the fastener each forms a straight segment substantially parallel to each other, the first lateral edge and the second lateral edge of the perimeter each comprises a first locking segment substantially perpendicular to the first facet and to the second facet, an intermediate locking segment substantially parallel to the first facet and to the second facet and a second locking segment substantially perpendicular to the first facet and to the second facet in such a way that the transverse cross-section of the fastener is generally T-shaped.

6. The fastener according to claim 4, characterized in that it comprises two lugs or a loop projecting from a body of the fastener, the lugs being positioned substantially parallel to each other, the loop being generally ring-shaped, the lugs, respectively the loop being intended to secure a wristband, respectively a chain, to the fastener.

7. A device comprising a personal accessory according to claim 1 and a fastener having a shape complementary to the slot of the accessory, the fastener being capable of being inserted into the slot of the accessory.

8. A watch comprising an accessory according to claim 1, and a fastener, the accessory comprising a cavity into which a watch movement is inserted, the accessory thus defining a watch case, the fastener having a shape complementary to the slot of the watch case, the fastener being capable of being inserted into the slot of the watch case.

9. The device according to claim 7, wherein the fastener is according to claim 4.

10. The watch according to claim 8, wherein the fastener is according to claim 4.
